(19) United States
(12) Patent Application Publication
(10) Pub. No.: US 2026/0023924 A1
(43) Pub. Date: Jan. 22, 2026

(54) INFORMATION PROCESSING METHOD, INFORMATION PROCESSING APPARATUS, INFORMATION PROCESSING SYSTEM, AND NON-TRANSITORY COMPUTER-READABLE STORAGE MEDIUM

(71) Applicant: LegalOn Technologies, Inc., Tokyo (JP)

(72) Inventors: Chie SUZUKI, Tokyo (JP); Akihiko MATSUBA, Tokyo (JP); Taizo YAMADA, Tokyo (JP)

(21) Appl. No.: 19/340,873

(22) Filed: Sep. 26, 2025

Related U.S. Application Data
(63) Continuation of application No. PCT/JP2023/012327, filed on Mar. 27, 2023.

(51) Int. Cl. G06F 40/194; G06F 40/169; G06F 40/186; G06F 40/289

(52) U.S. Cl. CPC G06F 40/194; G06F 40/169; G06F 40/186; G06F 40/289

(57) ABSTRACT

An information processing method according to an embodiment may compare a first document including a plurality of items to be reviewed with a second document including a plurality of items and in which indications are set to the plurality of items, determine whether the plurality of items of the first document are similar items or dissimilar items, generate a first display screen including the display in which the indication set in the second document is associated with the dissimilar item with respect to the dissimilar item and the display in which the indication simpler than the indication displayed when the item is the dissimilar item is associated with the similar item, and generate the second display screen in which the set indications are displayed with respect to the dissimilar item and the similar item, in which the first display screen and the second display screen can be switched and displayed.

### CROSS-REFERENCE TO RELATED APPLICATIONS

This application claims the benefit of International Application No. PCT/JP2023/012327, filed on Mar. 27, 2023, which is hereby incorporated by reference in its entirety. This application is a bypass continuation of the aforementioned international application.

### TECHNICAL FIELD

Embodiments of the present disclosure relate to an information processing method, an information processing apparatus, an information processing system, and a non-transitory computer-readable storage medium.

### BACKGROUND

For example, in a case where a plurality of contract parties (for example, two companies) enter into a contract, before entering into the contract, legal personnel of each contract party performs an examination work of considering countermeasures against the risk in the contract terms, such as recognition of the risk regarding the contract terms changed by the other party of the contract and determination as to whether or not to accept the contract terms (see, for example, Japanese Patent Application Laid-Open Publication No. 2010-092227). In the examination work, for example, document review for examining an agreement provided by the other party of the contract may be performed based on the own standard regarding the contract defined by the company.

### SUMMARY

An information processing method according to an embodiment compares a first document including a plurality of items to be reviewed with a second document including a plurality of items and in which indications are set to the plurality of items, determines whether the plurality of items of the first document are similar items or dissimilar items, generates a first display screen including the display in which the indication set in the second document is associated with the dissimilar item with respect to the dissimilar item and the display in which the indication simpler than the indication displayed when the item is the dissimilar item is associated with the similar item, and generates the second display screen in which the set indications are displayed with respect to the dissimilar item and the similar item, in which the first display screen and the second display screen can be switched and displayed.

### BRIEF DESCRIPTION OF DRAWINGS

FIG. 1 is a schematic diagram for describing an outline of a document review system according to an embodiment.

FIG. 2 is a block diagram illustrating an example of a hardware configuration of an information processing apparatus according to the embodiment.

FIG. 3 is a block diagram illustrating an example of a functional configuration of the information processing apparatus of the embodiment.

FIG. 4 is a block diagram illustrating an example of a hardware configuration of a terminal apparatus according to the embodiment.

FIG. 5 is a block diagram illustrating an example of a functional configuration of the terminal apparatus according to the embodiment.

FIG. 6 is a diagram illustrating an example of an initial display screen that is a document review screen displayed on a display of the terminal apparatus in document review processing according to the embodiment.

FIG. 7 is a diagram illustrating an example of a display screen transitioned from the initial display screen that is a document review screen displayed on the display of the terminal apparatus in the document review processing according to the embodiment.

FIG. 8 is a diagram for describing a clause in a review target document that is determined to have no clause corresponding to a template document in the document review processing according to the embodiment.

FIG. 9 is a diagram illustrating another example of the initial display screen that is a document review screen displayed on the display of the terminal apparatus in the document review processing according to the embodiment.

FIG. 10 is a flowchart illustrating an example of a flow of the document review processing according to the embodiment.

### DESCRIPTION

Hereinafter, embodiments of an information processing apparatus, an information processing system, an information processing method, an information processing program, and a recording medium according to the present disclosure will be described in detail with reference to the drawings. Note that, in the following description, components having substantially the same functions and configurations are denoted by the same reference numerals, and redundant description will be made when necessary. In addition, the embodiment can be appropriately combined with other embodiments, modifications, and/or conventional techniques.

The document review system according to the embodiment may be configured to function as a system that supports document evaluation, that is, document review. The document review system according to the embodiment may support the review of a first document based on a second document with indications necessary for the review of the first document. Here, the document review system according to the embodiment may be an example of an information processing system.

Conventional document review system may have room for further improvement from the viewpoint of the operation burden and convenience of the user.

An object to be achieved by an embodiment of the present disclosure is to support document examination work based on comparison between documents.

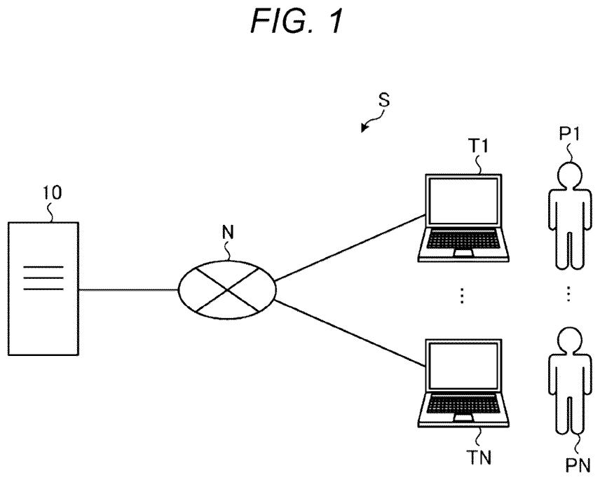

FIG. 1 is a schematic diagram for describing an outline of a document review system S according to an embodiment. As illustrated in FIG. 1, the document review system S of the present embodiment includes an information processing apparatus 10 and at least one terminal apparatus T1 to TN. In the document review system S, the information processing apparatus 10 and each of the at least one terminal apparatus T1 to TN may be configured to communicate with each other via a network N. In this embodiment, it is assumed that the at least one terminal apparatus T1 to TN is operated by users P1 to PN, respectively. Note that, in the following description, in a case where the at least one terminal apparatus T1 to TN is not distinguished, the terminal apparatus T1 operated by the user P1 will be described as an example.

Here, the document review system S of the present embodiment is a system that provides a document review service that supports document review on a browser. In the present specification, the document may mean documents in various languages created according to certain rules or standards such as certain regulations, laws, and conventions. In the present specification, the document may mean information expressing a document that is converted into data in an editable manner using document creation software or the like regardless of a data format. The document may be typically text data, but may also include other forms of data of text data, such as image data or tabular data. In addition, the document may include meta information (version, creation date, update date, creator, updater, or the like), format information (decoration such as underline and marker, font, indent, and the like), change history information, comment information, and the like created by document creation software as necessary.

Hereinafter, for the sake of specific description, a case where the document handled by the document review system S is a legal document (for example, an agreement) in Japanese will be described as an example. However, the document handled by the document review system S is not limited to agreements, and is not limited to Japanese documents. For example, it may be company regulations in English.

The document review service of the present embodiment may include executing the document review processing on a review target document on a web browser and providing a result of the processing to a user. Note that the document review service may be, for example, a service including at least one of executing document editing in response to an instruction from the user, saving the edited document or providing the edited document to the user, editing additional information (for example, meta information, comment information, chat information, format information, and the like) associated with the review target document or the template document, and creating a new document (including copy). Here, the review target document is an example of a first document. In addition, the template document is an example of a second document.

Note that, in the present specification, the document review processing may be processing of analyzing or evaluating information included in a review target document based on certain standards and outputting a result thereof. For example, the document review processing may be processing including checking and examining whether or not information included in the review target document is appropriate based on a template document serving as a standard. Specifically, it may include collating wording in the document with a prepared template document, and outputting a result of the collation and/or an indication included in the template document. In addition, editing may mean adding, deleting, or changing information included in an editing target. In the present embodiment, review processing is performed on the first document using the second document.

Note that, for example, in a case where the review target document is an agreement, the template document of the present embodiment is a model of an agreement in which texts of a single or a plurality of articles/sections are input in advance according to the type of the agreement, and a form and/or a format thereof is designated. In addition, the template document is not limited to a document prepared as a template in advance, and may be a review target document treated like a template as a result of increasing the frequency of use. In other words, the template document may be a document in which contents considered to be convenient for the user who uses the document review service are described. For example, in a case where the template document is an agreement, contract terms that the user considers to be preferable may be described in preferable expressions.

The meta information associated with the review target document or the template document may include, for example, a document ID, a type (for example, a type such as a basic transaction contract, a confidentiality contract, a service contract) of the document, a version, information of date and time such as a creation date and time, an update date and time, and an upload date and time of the document, information regarding a person such as a creator and an updater, a deadline of an answer to review or the other party, and a document ID of a related document.

The comment information associated with the review target document or the template document according to the embodiment may be, for example, additional information created by at least one user related to creation of the document, and may be associated and managed for each version of the review target document, for example. As an example, the comment information may be associated and managed with a specific version of the document of the review target document, or a specific sentence included in the specific version of the document. The comment information associated with the review target document or the template document may be information different from a comment typically created by the document creation software, and may include a comment created by the document creation software as necessary. Note that the information regarding the second document including the comment information may be set by those other than the user who intends to review the first document.

The chat information according to the embodiment may be, for example, additional information generated for a case related to a review target document or template document among a plurality of users related to creation of the document, and may be managed in association with, for example, a plurality of versions of the review target document or the template document. These pieces of additional information may be typically text data, but may also include other data formats such as image, voice, or the like.

Note that, in the present specification, the indication included in the template document may be an example of additional information associated with the template document. The indication can be made by, for example, the user P1 who reviews the review target document using a document review support service, a department such as a legal department to which the user P1 belongs, an organization such as a company, an external expert such as a counsel of the department or the company, a vendor who provides the document review support service or performs customization for the user, or a system of the document review support service. In the present disclosure, the indication may be information set with respect to the template document and used for examination of the document, and may be information indicating an issue regarding wording in the document such as an article of the template document, and can also be expressed as an own standard (a predetermined reference standard).

As an example, the indication may include any of information indicating an outline of a clause of the template document, information indicating a range or a content for which a concession can be made with respect to the other party or standards thereof, information indicating a range or a content for which a concession cannot be made with respect to the other party or standards thereof, information indicating an amendment proposal of the agreement assumed to be presented by the other party, information indicating a response content or an amendment proposal to the amendment proposal from the other party, and information indicating a sentence example (sentence draft) for conveying an intention of the amendment to a requesting department or the other party.

Note that the indication may be input/registered/saved, and associated in the document review system S as data or a document different from the template document.

Note that, in the document review processing, a check list prepared in advance for checking whether or not the information included in the review target document is appropriate may be used instead of or in addition to the template document.

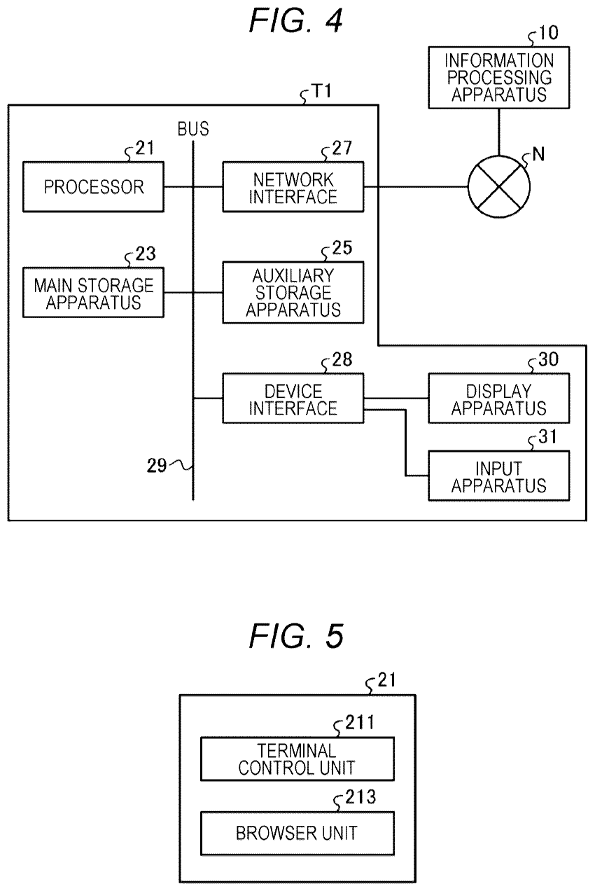

The terminal apparatus T1 of the present embodiment may be a client apparatus managed by the user P1 who uses the document review service. The terminal apparatus T1 may display a document review result and the own standard on a screen of a display apparatus 30 (see FIG. 4) while associating in position the document review result and the own standard with each other based on the information from the information processing apparatus 10, for example. In the embodiment, the user P1 can perform various operations related to document review such as document review reference, comment input, comment reference, chat information input, chat information reference, document editing processing, and document saving with respect to the review target document using the screen display by the display apparatus 30 of the terminal apparatus T1.

Next, specific configurations of the information processing apparatus 10 and the terminal apparatus T1 of the embodiment will be described.

### (Information Processing Apparatus 10)

The information processing apparatus 10 of the present embodiment may be an apparatus that is connected to a client apparatus by communication and performs various types of processing in response to a request from the client apparatus. For example, it may be a server apparatus managed by a provider side that provides a document review service. For example, the information processing apparatus 10 may provide a document review service to the terminal apparatus T1 in response to a document review request received from the terminal apparatus T1, which is a client apparatus, via the network N. Specifically, the information processing apparatus 10 of the embodiment executes document review processing of a document in the document review service. In addition, the information processing apparatus 10 may execute document editing processing in a document review service or a document creation support service cooperating with the document review service.

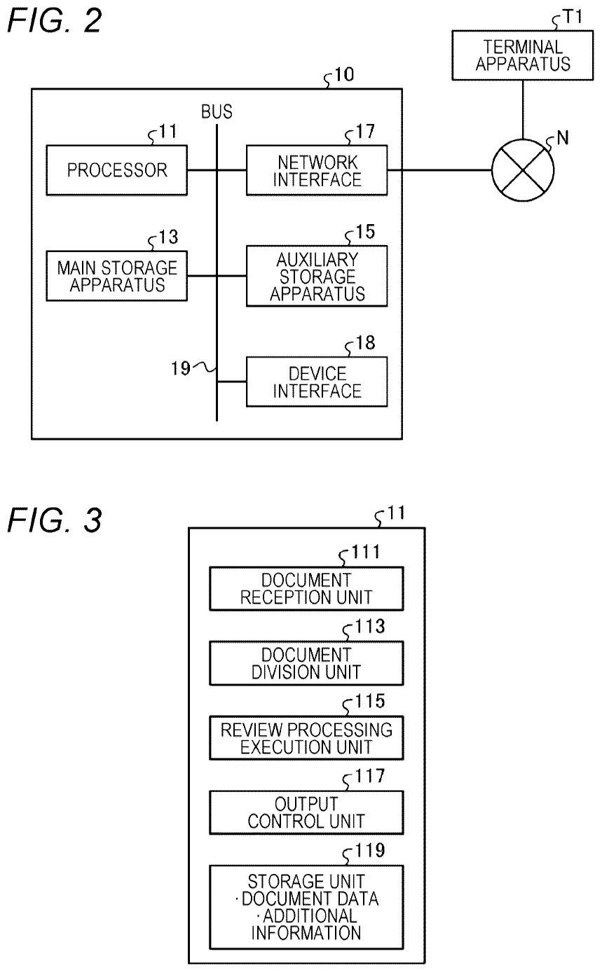

FIG. 2 is a block diagram illustrating an example of a hardware configuration of the information processing apparatus 10 according to the embodiment. For example, as illustrated in FIG. 2, the information processing apparatus 10 may have a configuration similar to that of a general computer, and include, as an example, a processor 11, a main storage apparatus (memory) 13, an auxiliary storage apparatus (memory) 15, a network interface 17, and a device interface 18. The processor 11, the main storage apparatus 13, the auxiliary storage apparatus 15, the network interface 17, and the device interface 18 may be communicably connected to each other via, for example, a bus 19.

Note that, although FIG. 2 illustrates the information processing apparatus 10 in which the number of each of components is one, but it is not limited thereto. The information processing apparatus 10 may include a plurality of the same components. In addition, although one information processing apparatus 10 is illustrated in FIG. 2, software may be installed in a plurality of computers, and each of the plurality of computers may execute the same or different partial processing of the software. In this case, there may be a form of distributed computing in which each of the plurality of computers communicates via the network interface 17 or the like to execute processing. That is, the information processing apparatus 10 according to the embodiment may be configured as a system that achieves various functions described below by one or a plurality of computers executing commands stored in one or a plurality of storage apparatuses.

Various operations of the information processing apparatus 10 may be executed in parallel processing using one or a plurality of processors or using a plurality of computers via a network. In addition, various operations may be distributed to a plurality of arithmetic cores in the processor and executed in parallel processing. In addition, some or all of the processing, means, and the like of the present disclosure may be executed by at least one of a processor and a storage apparatus provided on a cloud communicable with the information processing apparatus 10 via the network N. As described above, the processing of the document review system S of the present embodiment may be in the form of parallel computing by one or a plurality of computers.

The processor 11 may be an electronic circuit (process circuit, processing circuit, processing circuitry, central processing unit (CPU), graphics processing unit (GPU), field programmable gate array (FPGA), application specific integrated circuit (ASIC), or the like) including a control apparatus and an arithmetic apparatus of the information processing apparatus 10. In addition, the processor 11 may be a semiconductor apparatus or the like including a dedicated processing circuit. The processor 11 is not limited to an electronic circuit using an electronic logic element, and may be achieved by an optical circuit using an optical logic element. In addition, the processor 11 may include an arithmetic function based on quantum computing.

The processor 11 can perform arithmetic processing based on data or software (program) input from each apparatus or the like of the internal configuration of the information processing apparatus 10 and output an arithmetic result or a control signal to each apparatus or the like. The processor 11 may control each component constituting the information processing apparatus 10 by executing an operating system (OS), an application, or the like of the information processing apparatus 10.

The information processing apparatus 10 of the present embodiment may be achieved by one or a plurality of processors 11. Here, the processor 11 may refer to one or a plurality of electronic circuits disposed on one chip, or may refer to one or a plurality of electronic circuits disposed on two or more chips or two or more devices. When a plurality of electronic circuits is used, the electronic circuits may communicate in a wired or wireless manner.

The main storage apparatus 13 may be a storage apparatus that stores commands executed by the processor 11, various data, and the like, and information stored in the main storage apparatus 13 may be read by the processor 11. The auxiliary storage apparatus 15 may be a storage apparatus other than the main storage apparatus 13. Note that these storage apparatuses mean arbitrary electronic components capable of storing electronic information, and may be semiconductor memories. The semiconductor memory may be either a volatile memory or a nonvolatile memory. The storage apparatus for saving various data used in the information processing apparatus 10 according to the embodiment may be achieved by the main storage apparatus 13 or the auxiliary storage apparatus 15, or may be achieved by a built-in memory built in the processor 11. For example, a storage unit of the embodiment may be achieved by the main storage apparatus 13 or the auxiliary storage apparatus 15.

A plurality of processors may be connected (coupled) to one storage apparatus (memory), or a single processor 11 may be connected thereto. A plurality of storage apparatuses (memories) may be connected (coupled) to one processor. In a case where the information processing apparatus 10 of the embodiment includes at least one storage apparatus (memory) and a plurality of processors connected (coupled) to the at least one storage apparatus (memory), at least one processor among the plurality of processors may be configured to be connected (coupled) to the at least one storage apparatus (memory). In addition, this configuration may be achieved by storage apparatuses (memories) and the processors 11 included in the plurality of computers. Further, a storage apparatus (memory) may include a configuration of being integrated with the processor 11 (for example, a cache memory including an L1 cache and an L2 cache).

The network interface 17 is an interface for connecting to the network N wirelessly or by wire. As the network interface 17, it may be sufficient if an appropriate interface such as one conforming to an existing communication standard is used. The network interface 17 may exchange information with an external apparatus connected via the network N. Note that the network N may be any of a wide area network (WAN), a local area network (LAN), a personal area network (PAN), or the like, or may be a combination thereof, as long as information is exchanged between the information processing apparatus 10 and the external apparatus. Examples of the WAN include the Internet, examples of the LAN include IEEE802.11 and Ethernet (registered trademark), and examples of the PAN include Bluetooth (registered trademark) and near field communication (NFC).

The device interface 18 may be an interface such as a universal serial bus (USB) directly connected to an output apparatus such as a display apparatus, an input apparatus, and an external apparatus. In addition, the external apparatus may be a storage apparatus (memory), a network storage, a storage such as an HDD, or the like. In addition, the external apparatus may be an apparatus having some functions of the components of the information processing apparatus 10 according to the embodiment. That is, the information processing apparatus 10 may transmit or receive a part or the whole of the processing result of the external apparatus.

FIG. 3 is a block diagram illustrating an example of a functional configuration of the information processing apparatus 10 of the embodiment. For example, as illustrated in FIG. 3, the information processing apparatus 10 may have functions as a document reception unit 111, a document division unit 113, a review processing execution unit 115, an output control unit 117, and a storage unit 119. Specifically, at least one program for achieving each function of the information processing apparatus 10 may be stored in, for example, the main storage apparatus 13 or the auxiliary storage apparatus 15. The processor 11 can achieve each function of the information processing apparatus 10 by reading and executing the programs stored in the main storage apparatus 13, the auxiliary storage apparatus 15, or the like.

The document reception unit 111 may perform, for example, information communication with the terminal apparatus T1 via a network. Specifically, the document reception unit 111 may receive input of a review target document from the terminal apparatus T1. The document reception unit 111 may store the received review target document in the storage unit 119.

For example, the document division unit 113 may divide each of the input review target document and the template document stored in the storage unit 119 into units based on, for example, clauses constituting a legal document such as articles/sections/items. In the present embodiment, a unit based on clauses may be described as an item. Note that the template document may be preferably divided in advance and prepared in the storage unit 119. Here, the articles and sections of the review target document and the template document are examples of items of the review target document and the template document. It is possible to more appropriately extract and compare the additional information to be described below by dividing a sentence into units having unity of meaning such as articles and sections in a legal document such as an agreement. Note that it is preferable to divide a legal document written in English or whose governing law is the Law of the United States into units of items since one article is often relatively longer than that of a legal document conforming to the Japanese law in Japanese.

For example, the review processing execution unit 115 may execute the document review processing on the review target document received from the terminal apparatus T1 by using the template document. Note that the review processing execution unit 115 may execute the document review processing using a plurality of template documents. The review processing execution unit 115 may perform document review processing and generate document review information. The review information of the agreement as in the present embodiment can include information based on the additional information of the second document, for example, (1) indication as to whether the clause or the contract content included in the document (the agreement in the present embodiment) is advantageous or disadvantageous to the user (party), (2) advice regarding correction or deletion of the clause included in the agreement or the expression of the agreement, (3) indication of missing of an item that should be normally included in the agreement and/or suggestion of an item to be added, and (4) information of the importance and the degree of recommendation of the clause of each review result. In addition, what is not specified in the second document, for example, format information such as whether the format of the sentence meets the standard, whether a specified term is used, and other issues that are not included in the second document may be included.

The review processing execution unit 115 may perform, for example, the processing described below.

In the document review processing, the review processing execution unit 115 may extract, for example, information included in the first document and necessary for generating the review information. Various techniques can be adopted as a method for extracting the information from a document. For example, a keyword search of a document may be performed to extract characters/numbers/symbols, and the like included in the vicinity of the keyword. In addition, information can be extracted by morphological analysis, syntax analysis, semantic analysis, or context analysis. Further, information may also be extracted by natural language processing using machine learning. In addition, prior to these pieces of processing, a document necessary for document review such as text data may be extracted from the received data, or processing of extracting a document such as text data from image data by processing such as OCR may be performed. Note that the document review processing may be performed on the received document without extracting information necessary for generating the document review information as described above. In addition, these pieces of information may be included in the form of a table.

For example, in the document review processing, the review processing execution unit 115 may use the extracted information to compare the input review target document with the template document serving as the standard for the review target document. For example, the review processing execution unit 115 may compare the review target document with the template document. The comparison may include comparing the review target document with the template document for each item obtained by dividing into arbitrary units of clauses based on articles/sections, and the like, and include determining whether the item is a similar item or a dissimilar item for each item. Here, determining whether the item is a similar item or a dissimilar item may include at least one of determining whether the item is a similar item and determining whether the item is a dissimilar item. Alternatively, the comparison may include classifying each of the plurality of items into at least one of a similar item and a dissimilar item.

Note that the review processing execution unit 115 may classify the dissimilar item into two or more categories in the determination of whether the item is a similar item or a dissimilar item. As an example, first, the review processing execution unit 115 may determine whether the character strings roughly match. In this determination, the review processing execution unit 115 may classify an item that does not roughly match as a first dissimilar item. Next, the review processing execution unit 115 may determine whether an item that roughly matches exactly matches. In this determination, the review processing execution unit 115 may classify an item that exactly matches as a similar item. On the other hand, the review processing execution unit 115 may classify an item that does not exactly match as a second dissimilar item. In this case, in the display control described below, the first dissimilar item may be treated as an item for which the indication of the template document is displayed, similarly to the dissimilar item according to the embodiment. On the other hand, the second dissimilar item having a small dissimilarity, that is, substantially matching may be treated in the same manner as the dissimilar item according to the embodiment, or may be treated as an item for which simple display indicating that the wording does not match is indicated. As described above, with the configuration in which the dissimilar item is classified into two or more categories, the display mode can be further divided according to the degree of dissimilarity (dissimilarity). Accordingly, for example, even in a case where there are many dissimilar items for which indications are displayed, some of them are simply displayed according to the dissimilarity, so that the user can easily grasp the indications to be confirmed.

Note that the template document may be appropriately divided in order to facilitate comparison with the review target document. In particular, it is preferable to be divided into units similar to those of the review target document. The division may be performed, for example, by the document division unit described above. Note that, in the present specification, the divided items are not limited to those obtained by subdividing the original document, and also refer to items in a case where there is a document formed by a collection of a plurality of items. For example, it may be assumed that in a case where there is a template document in which clauses saved for each article are collected into one agreement, the clauses are not obtained by dividing the agreement, but are treated as divided items.

Then, for example, based on the comparison result between the review target document and the template document, the review processing execution unit 115 may extract the indication regarding a corresponding item of the template document as the document review information for each item of the review target document. Here, the indication regarding each item of the template document can include at least one of the comment information included in the template document and the additional information associated with the template document as described above.

As an example, for a similar item among a plurality of items included in the review target document, the review processing execution unit 115 may extract an indication regarding the item of the template document corresponding to the similar item. Here, the similar item may be an item of wording (for example, a text) in which a similarity to a sentence example (for example, a text) of a corresponding item of the template document satisfies a predetermined condition.

As an example, for a dissimilar item among a plurality of items included in the review target document, the review processing execution unit 115 may extract an indication regarding the item of the template document corresponding to the dissimilar item. Here, it may be assumed that the dissimilar item is an item of wording (for example, a text) in which a similarity to a sentence example (for example, a text) of a corresponding item of the template document does not satisfy a predetermined condition.

As an example, the review processing execution unit 115 may extract an indication that an additional item among a plurality of items included in the review target document is not included in the template document. Here, the additional item may be an item included in the review target document and an item not included in the template document. In addition, the indication that is not related to the item of the template document may be a standard that defines wording and contents defined in advance not to be described in the agreement or wording and contents defined in advance to be described in the agreement, and is a standard that does not depend on a specific item of the template document. In addition, the additional item can be included in a dissimilar item. Note that the indication regarding the additional item is not limited to the indication not related to the item of the template document, and may be extracted from the indication related to the item of another template document.

In addition, the review processing execution unit 115 may specify a missing item among a plurality of items included in the review target document. Here, the missing item may be an item included in the template document and an item not included in the review target document. Alternatively, the missing item may be an item corresponding to the indication not related to the item of the template document and is an item not included in the review target document. Note that, the missing item can be included in a dissimilar item.

Here, the similarity of the wording of the item of the review target document to the sentence example of the item of the template document may be based on, for example, a correlation between the wording of the item of the review target document and the sentence example (wording) of the corresponding item included in the template document. The degree of correlation of wording may be weighted by the correlation of the title of the item. As an example, the condition of the similarity may be that the wording of the item of the review target document matches the sentence example of the corresponding item included in the template document. As an example, the condition of the similarity may be that the wording of the item of the review target document and the sentence example of the corresponding item included in the template document match except for differences that are stored in advance in the storage unit 119 or are set by the user as allowable differences, such as a difference of “full width/half width”, a difference in notation such as “either/or”, and a name of a party in the sentence. As an example, the condition of the similarity may be that the correlation between the wording of the item of the review target document and the wording of the corresponding item included in the template document is equal to or greater than/equal to or less than a predetermined threshold, or exceeds/does not exceed the predetermined threshold. In this case, the numerical value of the correlation can be used as a value expressing the similarity. Note that it may be assumed that thresholds for the degree of correlation and the similarity are predetermined and stored in the storage unit 119 or the like. Note that the similarity may be, for example, a text-based (character-based) similarity based on matching/mismatching of a character string such as wording or a word of an item or a frequency thereof, or may be a vector-based similarity based on a vector of a character string such as wording or a word of a vectorized item. Note that the condition of the similarity may be fixed, and may be changed, for example, based on a condition such as a type of indication, a user, a contract type, or the like. In addition, it may be changed by the user or the provider of the system.

The first document of the present embodiment may be preferably created based on substantially the same document as the second document. In the document, although a substantially similar content (in the case of the agreement, the content of the contract) is defined, when expressions are different, when the text of the item of the first document and the text of the item of the second document are compared with each other, it may be determined that the similarity is low, and unnecessary indications may be displayed in the display described below. In particular, there may be such a problem when similarity is determined on a character basis. However, in a case where the first document is created based on the second document, for example, by replacing the name of the party, rewriting the contract content by the other party, or the like, the difference between the first document and the sentence of the second document serving as the review standard may become clear, and thus the data of the indication can be displayed more appropriately.

In addition, the review processing execution unit 115 may generate the document review information according to the position of the user (party) by using the meta information associated with the review target document. Further, the review processing execution unit 115 can also generate the document review information with reference to the contents of other documents (other versions of the review target document, other agreements related to the review target document, or the like). The meta information may include those given to a document file itself such as a creator of the document and those given by a user or the like by being input separately from the file.

The output control unit 117 may perform, for example, information communication with the terminal apparatus T1 via a network. Specifically, the output control unit 117 may output at least the document review information to the terminal apparatus T1.

Note that the document review information may include layout information. Here, the layout information in the document review processing may be information for displaying the document review information generated by the document review processing and the review target document in a predetermined form in association with each other in position on the browser screen of the terminal apparatus T1.

Note that the association with each other in position may refer to associating display positions so as to contribute to browsing by the user, and specifically may mean associating the positions on the screen, for example, in units of clauses, in units of paragraphs, and in units of sentences. Association in position may include, for example, displaying the corresponding portions closer to each other in the height or width direction than the other portions on the screen, and more preferably, displaying the corresponding portions side by side. For example, when the review target document has a similar item to the template document, it may include displaying similar items of the review target document and the template document in the same row and in different columns in a tabular form.

The generation of the layout information may be performed by any method. For example, regarding a word and a phrase included in the item of the template document corresponding to the indication as the review target document, the degree of matching may be scored for each position (for example, for each position in units of clauses or each position in units of paragraphs) in the review target document by a search function, and the layout information may be generated such that the document review information is displayed corresponding to the position of the highest score. In addition, for example, by assigning coordinates in units of clauses or in units of paragraphs of the review target document and associating the coordinates with the corresponding document review information, it is also possible to associate the display positions of the clauses and the paragraphs with the document review information.

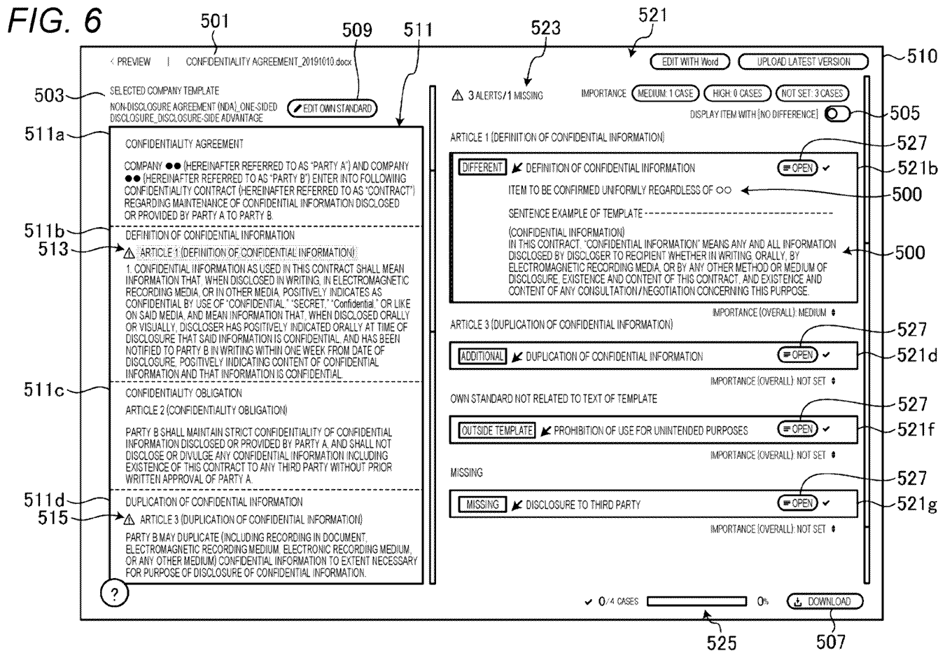

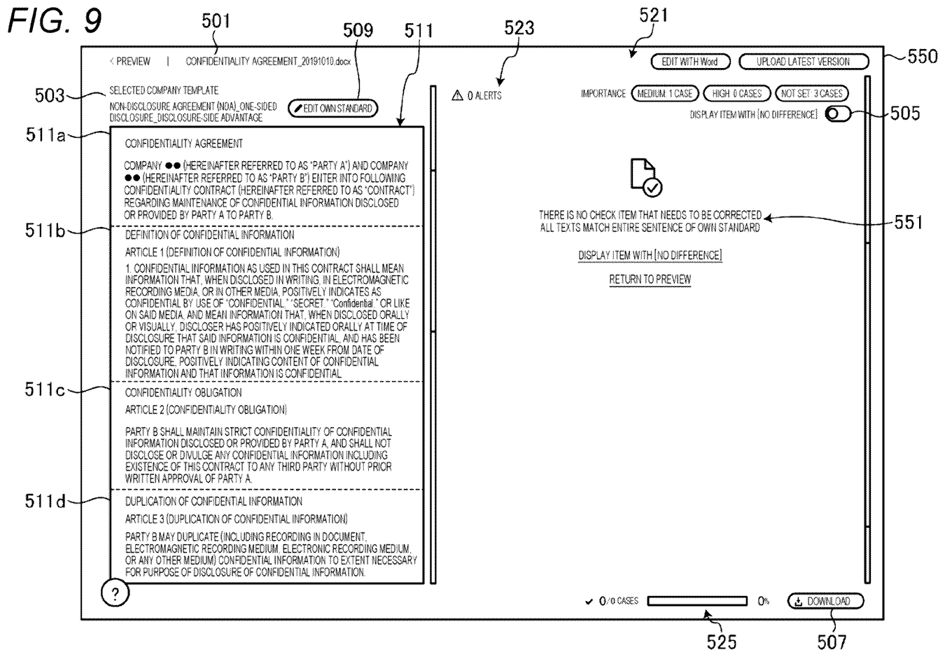

As an example, the output control unit 117 may generate display information for displaying the initial display screen (see FIG. 6 or 9) including the document review information, and output the display information to the terminal apparatus T1. Here, it may be assumed that the initial display screen is a display screen displayed on the terminal apparatus T1, and is a display screen that displays, as the document review information, at least one item of a dissimilar item, an additional item, and a missing item of the review target document and the indication of the template document corresponding to the item in association with each other in position. Here, the initial display screen is an example of a first display screen.

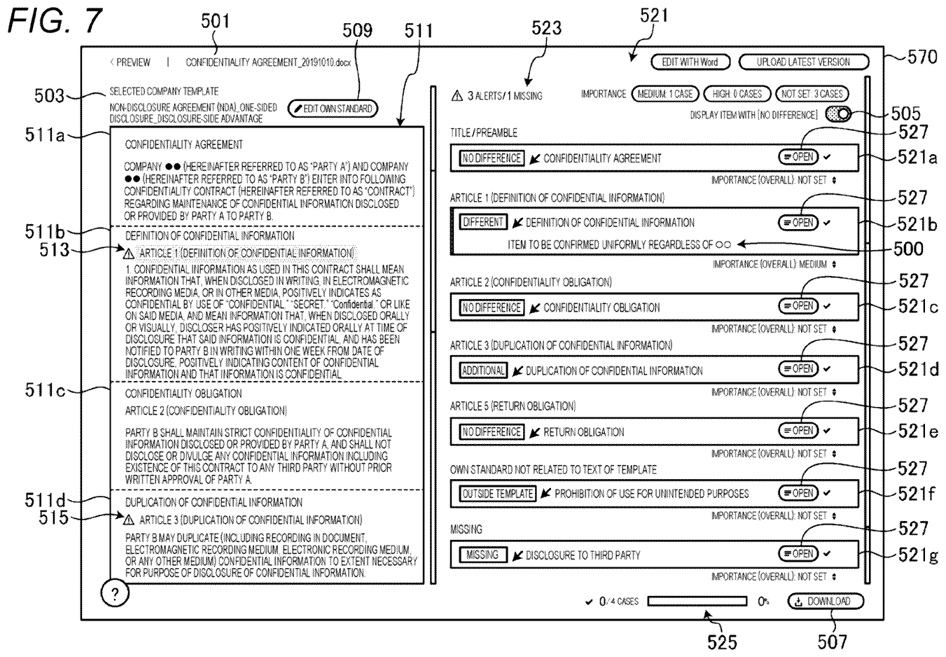

As an example, the output control unit 117 may generate display information for displaying the full display screen (see FIG. 7) including the document review information, and output the display information to the terminal apparatus T1. Here, it may be assumed that the full display screen is a display screen displayed on the terminal apparatus T1, and is a display screen that further displays, as the document review information, a similar item of the review target document and the indication of the template document corresponding to the similar item in association with each other in position with respect to the initial display screen. Here, the full display screen is an example of a second display screen.

Note that, in the present disclosure, the initial display screen may be, for example, a screen displayed on the terminal apparatus T1 before a user operation related to indication display is performed, but is not necessarily limited to a screen displayed as initial display in the document review service on the terminal apparatus T1. In addition, in the description of the present embodiment, a case where the full display screen may be displayed on the terminal apparatus T1 by screen transition from the initial display screen, that is, a case where the initial display screen is set as a default display screen is exemplified, but it is not limited thereto. The full display screen may be set as a default display screen, and the initial display screen may be displayed on the terminal apparatus T1 by screen transition from the full display screen.

In addition, the output control unit 117 may output an indication included in the display screen among a plurality of indications included in the template document, for example, in response to a download instruction from the terminal apparatus T1. As an example, when the initial display screen is displayed, the output control unit 117 may preferably collectively output the indication regarding at least one item of the dissimilar item, the additional item, and the missing item. As an example, when the full display screen is displayed, the output control unit 117 may collectively output the indication regarding at least one item of the similar item, the dissimilar item, the additional item, and the missing item. Note that the file format when the displayed indication is output is arbitrary. This file format may be a file format conforming to specific spreadsheet software or document creation software such as Microsoft Excel or Microsoft Word, or arbitrary spreadsheet software or document creation software, or may be another file format such as a PDF format or a CSV format.

The storage unit 119 may store various programs to be executed in the information processing apparatus 10. In addition, the storage unit 119 may store a document uploaded from the terminal apparatus T1, additional information associated with each document, and the like.

### (Terminal Apparatus T1)

The terminal apparatus T1 of the present embodiment may transmit and receive information related to display of a document and a document review result to and from the information processing apparatus 10 in the document review service.

FIG. 4 is a block diagram illustrating an example of a hardware configuration of the terminal apparatus T1 according to the embodiment. As illustrated in FIG. 4, the terminal apparatus T1 of the present embodiment may have a configuration similar to that of a general computer and includes, as an example, a processor 21, a main storage apparatus (memory) 23, an auxiliary storage apparatus (memory) 25, a network interface 27, a device interface 28, the display apparatus 30, and an input apparatus 31. The processor 21, the main storage apparatus 23, the auxiliary storage apparatus 25, the network interface 27, and the device interface 28 may be communicably connected to each other via, for example, a bus 29. The display apparatus 30 and the input apparatus 31 may be both connected to the device interface 28.

The processor 21, the main storage apparatus 23, the auxiliary storage apparatus 25, the network interface 27, and the device interface 28 may be hardware configurations similar to the processor 11, the main storage apparatus 13, the auxiliary storage apparatus 15, the network interface 17, and the device interface 18, respectively.

The display apparatus 30 may be, for example, a display apparatus such as a liquid crystal display (LCD), a cathode ray tube (CRT), a plasma display panel (PDP), or an organic electro luminescence (EL) panel. The display apparatus 30 may display, for example, a document review screen to be described below based on an instruction from the processor 21.

The input apparatus 31 may be, for example, a device such as a keyboard, a mouse, or a touch panel. The input apparatus 31 receives various operation inputs by the user P1, for example, in the document review processing to be described below. The input apparatus 31 may output a result of the operation input received from the user P1 to the processor 21.

Note that another external apparatus such as a camera, a microphone, motion capture, or various sensors may be connected to the terminal apparatus T1 via the device interface 18.

FIG. 5 is a block diagram illustrating an example of a functional configuration of the terminal apparatus T1 according to the embodiment. As illustrated in FIG. 5, the terminal apparatus T1 of the present embodiment may have functions as a terminal control unit 211 and a browser unit 213. Specifically, at least one program for achieving each function of the terminal apparatus T1 may be stored in, for example, the main storage apparatus 23 or the auxiliary storage apparatus 25. The processor 21 can achieve each function of the terminal apparatus T1 by reading and executing the programs stored in the main storage apparatus 23, the auxiliary storage apparatus 25, or the like.

For example, the terminal control unit 211 may activate the browser unit 213 in response to an instruction from the user.

The browser unit 213 may be, for example, a general web browser, and execute processing according to hyper text markup language (HTML) data, a script (for example, Java (registered trademark) Script), or the like. When activated, the browser unit 213 may transmit an initial access URL to the information processing apparatus 10 to access.

The browser unit 213 may display, for example, data including text data and image data received from the information processing apparatus 10 on the display apparatus 30 of the terminal apparatus T1 in a predetermined form. More specifically, in the document review processing, the browser unit 213 may display the document review information and the document received from the information processing apparatus 10 on the display apparatus 30 of the terminal apparatus T1 in a predetermined form based on the layout information.

FIG. 6 is a diagram illustrating an example of an initial display screen (first display screen) 510 that is a document review screen displayed, as a web browser screen, on the display apparatus 30 of the terminal apparatus T1 in the document review processing according to the embodiment.

For example, as illustrated in FIG. 6, the initial display screen 510 may include display 501 of information indicating a review target document such as a file name, and display 503 of information indicating a template of a selected user, that is, a template document created according to the own standard. In addition, the initial display screen 510 may include an icon 509 for instructing editing of the own standard, that is, change or correction of the template document. The terminal control unit 211 of the terminal apparatus T1 may receive the selection of the icon 509 and request the information processing apparatus 10 to edit the own standard. At this time, the information processing apparatus 10 may execute processing regarding editing of the own standard in response to a request from the terminal apparatus T1.

For example, as illustrated in FIG. 6, the initial display screen 510 may include a document display area 511 for displaying the review target document and a document review area 521 for displaying the document review information.

In the example illustrated in FIG. 6, a first clause 511a, a second clause 511b, a third clause 511c, and a fourth clause 511d may be displayed in the document display area 511 of the initial display screen 510 as the divided clauses of the review target document. Here, the first clause 511a and the third clause 511c are both examples of the similar item. In addition, the second clause 511b is an example of the dissimilar item determined to have a certain difference from the template document. In addition, the fourth clause 511d is an example of the additional item (dissimilar item). That is, in the present embodiment, both the similar item and the dissimilar item may be displayed in the document display area 511 of the initial display screen 510.

In the example illustrated in FIG. 6, the document review area 521 of the initial display screen 510 may display indications regarding the dissimilar items among the divided clauses of the review target document, that is, a second indication 521b regarding the second clause 511b and a fourth indication 521d regarding the fourth clause 511d. In addition, in the document review area 521 of the initial display screen 510, a sixth indication 521f based on the own standard not related to the items of the template document may be displayed. In addition, in the document review area 521 of the initial display screen 510, a seventh indication 521g regarding the missing item that does not exist in the divided clauses of the review target document may be displayed.

On the other hand, in the example illustrated in FIG. 6, in the document review area 521 of the initial display screen 510, the indications regarding the similar items among the divided clauses of the review target document, that is, a first indication 521a and a third indication 521c (see FIG. 7) regarding the first clause 511a and the third clause 511c, respectively, may not be displayed. With such display, the user can easily grasp only the indication regarding the item altered by the other party of the contract among a plurality of indications of the template document. As a result, it is possible to reduce the time and effort related to the examination work of the agreement and to support the examination work of the document based on the comparison between the documents.

Examples of the simple display may include not displaying the indication itself as in the present embodiment, and displaying only a title or a part of the indication so as not to display the entire text of the indication.

Note that, in the present embodiment, the sixth indication 521f based on the own standard not related to the items of the template document and the seventh indication 521g related to the missing item may be displayed as simple indications with only a part of the sentences (for example, the titles) of the indications being displayed, but, in order to improve convenience of review by the user, the indication may be displayed similarly to the indication (the second indication 521b and the fourth indication 521d in FIG. 6) related to the dissimilar item having a difference from the template document.

In addition, as in the fourth indication 521d, even in a case where the indication determined to be the additional item is not an exact matching similar item (the above-described second dissimilar item), the indication may preferably be displayed since the item has been added to the agreement, but the display of the indication may be omitted in a case where the indication is an exact matching similar item.

Note that, in the example illustrated in FIG. 6, the clause and the indication related to the indication may be displayed to be closer to each other than the other clauses. For example, the second indication 521b directed to the second clause 511b of “Article 1 (Definition of Confidential Information)” may be displayed such that the position in the screen height direction of “Article 1 (Definition of Confidential Information)” of the review target document is closer than the other clauses. The document review information may preferably be displayed in a list in an area not overlapping with the portion of the document indicated by the indication item, for example, the document review area 521 aligned with the document display area 511, or an independent (individual) window such as a pop-up window. With such display, the portions corresponding to the review target document and the indication can be compared with each other with less movement of the line of sight, and the burden on the user can be reduced.

Note that the association in position between the document display area 511 and the document review area 521 may be temporary. For example, in a state in which the review target document and the indication are not associated with each other in position between the document display area 511 and the document review area 521, and the review target document and the indication are displayed in each of the document display area 511 and the document review area 521, the position association display between the review target document and the indication may be executed, for example, by moving the item of the review target document or the indication in response to a predetermined operation such as inserting a cursor into the item with respect to the review target document or clicking near the item. In addition, the position association display between the review target document and the indication may be released by a predetermined operation.

In addition, a scroll bar for scrolling the displayed document or indication in an up-down direction may be displayed next to each of the document display area 511 and the document review area 521. The review target document displayed in the document display area 511 and the indication displayed in the document review area 521 may be scrolled by an operation of the scroll bar or the like. In addition, in a case where either one of the review target document and the indication is scrolled in the up-down direction, for example, the other may also be scrolled in the up-down direction in conjunction with this.

In addition, for example, the number of results of indication may be indicated for each importance. In the example illustrated in FIG. 6, characters “importance” and the number of indications classified as the importance may be displayed in the upper part of the document review area 521.

In addition, in the initial display screen 510 of the example illustrated in FIG. 6, a toggle 505 for instructing display of an item of “no difference”, that is, display of an indication regarding the similar item may be displayed. The user can switch whether or not to filter the indication regarding the similar item, that is, whether or not to display the indication regarding the similar item by operating the toggle 505. In the present embodiment, no difference may mean that there is no difference in characters (all characters match) between corresponding items of the first document and the second document. In addition, the user may select whether to display or switch the second dissimilar item described above.

FIG. 7 is a diagram illustrating an example of a full display screen (second display screen) 570 transitioned from the initial display screen 510 that is a document review screen displayed, as a web browser screen, on the display apparatus 30 of the terminal apparatus T1 in the document review processing according to the embodiment. The full display screen 570 in FIG. 7 may be, for example, a display screen in which the web browser screen is switched and displayed in response to the operation of the toggle 505 on the initial display screen 510 in FIG. 6.

In the example illustrated in FIG. 7, the document review area 521 of the full display screen 570 (second display screen) may display the first indication 521a, the second indication 521b, the third indication 521c, the fourth indication 521d, and a fifth indication 521e corresponding respectively to the first clause 511a, the second clause 511b, the third clause 511c, the fourth clause 511d, and a fifth clause obtained by dividing the review target document. In addition, the document review area 521 may display the sixth indication 521f based on the own standard and the seventh indication 521g regarding the missing item. That is, as illustrated in FIG. 7, the document review area 521 of the full display screen 570 further may include the first indication 521a, the third indication 521c, and the fifth indication 521e regarding the similar items of the review target document with respect to the initial display screen 510. Note that it may be assumed that the other indications are displayed but omitted in the drawings.

Note that the full display screen 570 of the present embodiment may be an example of a screen on which the indication related to the similar item is also displayed and may not mean to display all the clauses of the review target document. Similarly, the full display screen 570 may not necessarily mean to display all the indications included in the document review information. For example, the clauses and indications included in the screen display can appropriately change according to various conditions such as the size of the display surface of the display apparatus 30 of the terminal apparatus T1, the screen size of the full display screen 570 on the display surface, the font size on the display surface, and other conditions.

Each indication regarding the similar item may preferably be displayed at a position corresponding to the similar item similarly to the dissimilar item and the indication regarding the dissimilar item.

As illustrated in FIG. 7, the first indication 521a, the third indication 521c, and the fifth indication 521e regarding the similar items may be indications simpler than the indications set in the template document. Note that the first indication 521a, the third indication 521c, and the fifth indication 521e displayed regarding the similar items may be displayed in a simpler manner than the second indication 521b displayed regarding the dissimilar item, but may be displayed in a similar manner. In addition, the fourth indication 521d, the sixth indication 521f, and the seventh indication 521g displayed regarding the dissimilar items may also be displayed in a simpler manner than the second indication 521b, but may be displayed in a similar manner.

In addition, also on the full display screen 570 of FIG. 7, the toggle 505 may be displayed similarly to the initial display screen 510 of FIG. 6. Regarding this toggle 505, in the present embodiment, the display of the toggle 505 may be display for instructing transition from the initial display screen 510 to the full display screen 570. As illustrated in FIG. 7, display for instructing transition from the initial display screen 510 to the full display screen 570 and display for instructing transition from the full display screen 570 to the initial display screen 510 may be displayed by one toggle.

Note that, as illustrated in FIGS. 6 and 7, the display of each indication may include an open icon 527 for instructing detailed display. FIG. 6 illustrates a case where the open icon 527 is selected with respect to the second indication 521b regarding the dissimilar item. On the other hand, as illustrated in FIGS. 6 and 7, for example, in either a first screen or a second screen, a comment indicating an outline of the indication may be displayed as indication information 500. In addition, as illustrated in FIG. 6, regarding the indication for which an instruction of detailed display is given, more detailed indication information 500 such as a sentence example in the template document may be displayed in addition to the outline of the indication.

In addition, display may be made so that the user can easily confirm whether the indication is a dissimilar item or a similar item of the review target document. For example, as illustrated in FIGS. 6 and 7, caution marks 513 and 515 may be displayed at the heads of the second clause 511b and the fourth clause 511d, so that it is easy to visually recognize that they are dissimilar items. In addition, for example, the background color of the portion of the dissimilar item may be made different from that of the similar item. In addition, for example, emphasis display such as highlighting as in the second clause 511b and the second indication 521b in FIGS. 6 and 7 or bolding the clause may be performed. The emphasis display of the clause may be performed on a difference portion between the sentence example of the item of the template document and the sentence of the dissimilar item of the review target document with respect to the sentence example in at least one of the sentence of the item of the review target document and the sentence example of the indication information 500. This may make it easier to compare documents.

The display may be changed based on the importance of the indication. For example, it is possible to set such that an indication with a high degree of importance is displayed on the first display screen because the necessity of confirmation is high among dissimilar items, and an indication with a medium degree of importance is hidden. This may be performed by pre-setting, or the user may switch between display and hiding by operating an icon related to the importance disposed in the screen during the review of the document.

It may be determined that there is no corresponding item in the template document of the own standard among the items of the review target document. With respect to such an item in the review target document, display of an indication that there is no corresponding item in the template document or emphasis display of the text may be performed. This indication may preferably be displayed on a first display screen 520 because it is considered to be important or necessary to be confirmed by the user similarly to the indication of the dissimilar item. The indication to be displayed can be “an item for which there is no corresponding item in the template document”, or the like.

There may be a high possibility that the clause determined not to be present in the template document of the own standard is newly added by the other party, greatly rewritten by the other party, or greatly deviated from the own standard, and it may be considered that it is preferable to carefully confirm the content in many cases. Under such circumstances, with the above configuration, attention of the user can be paid to a clause determined not to be present in the template document of the own standard. In addition, it is possible to emphasize the clause by performing emphasis display or alert. Accordingly, with the above configuration, the user can easily grasp the clause to be confirmed and more easily compare the documents.

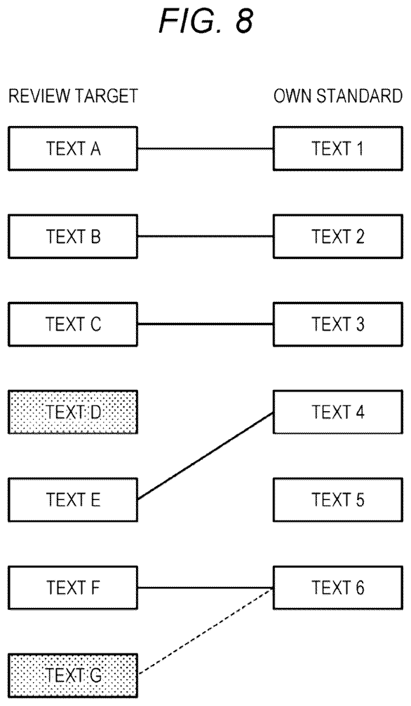

FIG. 8 is a diagram for describing an example of a method of determining similarity of items in a review target document. In particular, a case where it is determined that there is no corresponding clause in the template document in the document review processing according to the embodiment will be described.

In FIG. 8, the clauses of “Text A”, “Text B”, “Text C”, “Text E”, and “Text F” of the review target document may be clauses that can be compared with the clauses of “Text 1”, “Text 2”, “Text 3”, “Text 4”, and “Text 6” of the template document, and may be examples of the clauses classified into similar items or dissimilar items by the comparison. On the other hand, “Text 5” of the template document corresponds to a missing item that may not be included in the review target document.

In addition, in FIG. 8, the clause of “Text D” of the review target document may be an example of a dissimilar item that there is no similar text in the template document of the own standard.

For example, the clause of “Text D” may be a clause newly added by the other party in a case where the review target document is a document obtained by editing the template document of the own standard or a document created using the template document by the other party of the contract.

In addition, for example, the clause of “Text D” may be a clause having a large difference from the original clause due to editing of an existing clause by the other party in a case where the review target document is a document obtained by editing the template document of the own standard or a document created using the template document by the other party of the contract. That is, the clause of “Text D” can be expressed as a clause that has been significantly changed to such an extent that the clause is not determined to be “similar” to the clause of the original template document of the own standard in comparison of the documents.

In addition, for example, the clause of “Text D” may be a clause in a case where the review target document is a document created by the other party such as the standard template document of the other party, and there may be no similar clause in the template document of the own standard. This clause of “Text D” may correspond to, for example, an additional item of the fourth clause 511d in the above-described example.

In addition, in FIG. 8, the clause of “Text G” of the review target document may be an example of a dissimilar item that there is no similar text in the template document of the own standard.

For example, the clause of “Text G” may be a clause in a case where the review target document is a document created by the other party, such as the standard template document of the other party, and there may be a similar clause in the template document of the own standard, and the clause of the template document of the own standard may be an item already matched (determined to be similar) as being similar to other clauses of the review target document. In the example of FIG. 8, the clause of “Text G” may be similar to the clause of “Text 6” of the template document of the own standard, but the clause of “Text 6” may be already matched as being similar to the clause of “Text F” of the review target document. This clause of “Text G” may correspond to, for example, an additional item of the fourth clause 511d in the above-described example.

Note that, although the method of associating the clauses on a one-to-one basis in the matching between the documents is simple, it is possible to determine that there is no similar text in the template document of the own standard when the clauses having the same content are duplicate in the review target document regardless of whether the template document is of the own standard or of the other party's. Since such duplicate items also need to be confirmed by the user, it is preferable to display the indication as a dissimilar item that there is no similar text in the template document of the own standard, for example.

Note that highlighting display of the dissimilar item that there is no similar text in the template document of the own standard, such as “Text D” and “Text G” in FIG. 8, may be applied to all the clauses in the document display area 511 that displays the review target document, for example. As an example, the highlighting display may be performed on the entire sentence (text) of the dissimilar item that there is no similar text in the template document of the own standard. As an example, the highlighting display may be performed in an aspect in which background cells of the dissimilar item that there is no similar text in the template document of the own standard are colored.

In addition, for the dissimilar item that there is no similar text in the template document of the own standard, such as “Text D” and “Text G” in FIG. 8, for example, an alert indicating that there is no corresponding text in the template may be displayed in the document review area 521 displaying the document review information.

FIG. 9 is a diagram illustrating an example of an initial display screen 550 that is a document review screen displayed, as a web browser screen, on the display apparatus 30 of the terminal apparatus T1 in the document review processing according to the embodiment.

The initial display screen 550 illustrated in FIG. 9 may be an example of the initial display screen 510 in a case where there is no indication regarding the dissimilar item. In the example illustrated in FIG. 9, in the document review area 521 of the initial display screen 550, a comment indicating that there is no dissimilar item or that there is no difference in wording between the template document and the review target document, such as “There is no check item that needs to be corrected. All the texts match the entire sentence of the own standard”, a comment 551 including a link that functions similarly to the toggle 505 such as “Display item with no difference”, or a link such as “Return to preview” for returning to the display before the document review processing is executed may be displayed.

In addition, also on the initial display screen 550 of FIG. 9, the toggle 505 may be displayed similarly to the initial display screen 510 of FIG. 6. That is, the full display screen 570 in FIG. 7 can also be expressed as, for example, a display screen in which the web browser screen is switched and displayed in response to the operation of the toggle 505 on the initial display screen 550 in FIG. 9.

Note that, as illustrated in FIGS. 6 to 8, on each of the display screens 510, 550, and 570, information 523 indicating a summary of review results, such as a count of alerts and a count of missing items, displayed in the document review area 521, and information 525 indicating a progress status for addressing the indications, such as a number of addressed items relative to a total number of items, may be displayed.

In addition, as illustrated in FIGS. 6 to 8, a download icon 507 for instructing download of data related to the indication may be displayed on each of the display screens 510, 550, and 570. The user can operate the download icon 507 to collectively download data including the displayed indication, for example. Specifically, the terminal control unit 211 of the terminal apparatus T1 may receive the selection of the download icon 507 and request the information processing apparatus 10 to output the indication information. At this time, the information processing apparatus 10 may execute processing of outputting the displayed indication as one data in response to a request from the terminal apparatus T1. For example, when receiving the selection of the download icon 507 on the initial display screen 510, the information processing apparatus 10 may collectively output a plurality of indications except for the indications regarding similar items. For example, when receiving the selection of the download icon 507 on the initial display screen 510, the information processing apparatus 10 may collectively output a plurality of indications including the indications regarding similar items.

### (Flow of Document Review Processing)

Next, an example of document review processing achieved by the information processing apparatus 10 according to the embodiment will be described.

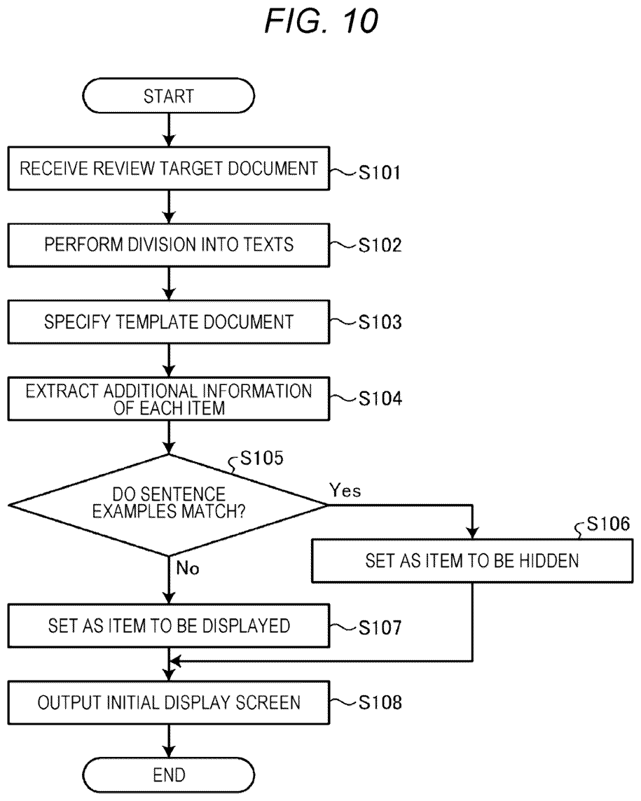

FIG. 10 is a flowchart illustrating an example of a flow of the document review processing according to the embodiment.

The flow of FIG. 10 exemplifies a flow executed in the information processing apparatus 10 after the browser unit 213 is activated in the terminal apparatus T1 in response to an instruction from the user and the review target document is transmitted to the information processing apparatus 10 by the browser unit 213 in response to a document upload instruction from the user.

The document reception unit 111 of the information processing apparatus 10 may receive input of the review target document from the terminal apparatus T1 (S101). In addition, the document division unit 113 may divide the input review target document in units of items (S102).

This review target document may be changed by the other party to the negotiation to which the template document of the user has been sent. The original template document of the review target document may be stored in the storage unit 119 of the information processing apparatus 10 and output. In addition, it is preferable that the original template document of the review target document has substantially the same content as the template document used in the review. As a result, the difference in performing the review becomes clearer, and the review can be facilitated. Note that, in this case, the template document to be sent to the other party may preferably be output from the system or sent to the other party in a state in which information to be used by the user such as an indication or a comment is not included. The template document may be sent to the other party to the negotiation directly from the system or from a user who has performed download to the other party.

Thereafter, the review processing execution unit 115 may specify divided items of the corresponding template document for each divided item of the review target document (S103), and extract additional information, that is, an indication, added to each item of the specified template document (S104).

In addition, the review processing execution unit 115 may determine, for each item, whether or not the sentence examples match between the review target document and the template document (S105).

When the sentence examples match (S105: Yes), the review processing execution unit 115 may set the corresponding item as a similar item for which indication of the template document is hidden on the initial display screen 510 (S106). On the other hand, when the sentence examples do not match (S105: No), the review processing execution unit 115 may set the corresponding item as a dissimilar item for which indication of the template document is displayed on the initial display screen 510 (S107).

Thereafter, the output control unit 117 may output the document review information for the initial display screen excluding the indication regarding the similar item to the terminal apparatus T1 (S108). At this time, the browser unit 213 of the terminal apparatus T1 may display the initial display screen 510 (or the initial display screen 550) based on the document review information and the layout information received from the information processing apparatus 10.

The information processing apparatus 10 according to the embodiment of the present embodiment may include at least one processor. The at least one processor may achieve the document reception unit 111, the document division unit 113, the review processing execution unit 115, the output control unit 117, and the storage unit 119. The at least one processor may compare the review target document including a plurality of items to be reviewed with the template document. Here, the template document may be a document that includes a plurality of items, in which indications are set for the plurality of items, and that may be used as the standard for the review target document. In addition, the at least one processor may determine whether the plurality of items of the review target document are similar items or dissimilar items. In addition, the at least one processor may generate the initial display screen 510 including display in which the indication set in the template document is associated with the dissimilar item with respect to the dissimilar item and display in which the indication simpler than the indication displayed when the item is the dissimilar item is associated with the similar item. In addition, the at least one processor generates the full display screen 570 on which the set indication is displayed for the dissimilar item and the similar item. In addition, the at least one processor can switch and display the initial display screen 510 and the full display screen 570.

Accordingly, for example, in a state where the agreement body and the document review result of the agreement may be displayed side by side, it is possible to achieve an online document review service that moves on a browser displaying only an indication regarding a change portion from the template document. As a result, it is possible to reduce the time and effort related to the examination work of the agreement and to support the examination work of the document based on the comparison between the documents. For example, while referring to the document review information displayed on the display screen, the user can easily consider what kind of indication item exists, how to correct, and the like regarding the alteration of the agreement by the other party of the contract.

In addition, the indication regarding the similar item filtered and hidden on the initial display screens 510 and 550 can be appropriately confirmed on the full display screen 570. In addition, by causing the indication regarding the similar item to be an indication simpler than the indication set in the template document, the indication to be confirmed can be easily grasped even when the indication regarding the similar item is displayed.

In addition, in the information processing apparatus 10, the initial display screen 510 may include display of the toggle 505 for instructing transition to the full display screen 570.

Accordingly, even when the review target document is not altered from the template document, the screen display can be switched from the initial display screens 510 and 550 to the full display screen 570. For example, when considering the indication displayed on the initial display screens 510 and 550, there may be a case where it is desired to confirm the text of other hidden articles/sections. Under such circumstances, with the above configuration, the indication regarding the similar item filtered and hidden on the initial display screens 510 and 550 can also be appropriately confirmed.

In addition, in the information processing apparatus 10, the indication regarding the item of the template document corresponding to the dissimilar item may include at least one of the comment information included in the template document and the additional information associated with the template document.

The editing of the own standard used with respect to the review target document is not limited to editing of the template document, and may be addition, update, deletion, or the like of the template document. Even in the case of a template document that cannot be corrected such as a PDF format so that it is not corrected, in a case where the indication cannot be edited, or in a case where a correction proposal is made in another document of the agreement such as an e-mail, the own standard may be edited by adding the template document with the indication. Note that when the template document is updated, the indication attached to an old version template document may be transcribed to a new version template document. For example, the old version template document and the new version template document may be compared in units of clauses, and an indication attached to a clause of the old version template document may be transcribed as an indication of a clause of the new version template document that is similar to the above clause.

In addition, in the information processing apparatus 10, the full display screen 570 may include display of the toggle 505 for instructing transition to the initial display screens 510 and 550.

Accordingly, the indication regarding the similar item can be arbitrarily switched between display/hiding.

In addition, in the information processing apparatus 10, the template document may include an indication that is not related to the item. In addition, in the information processing apparatus 10, the initial display screen 510 may further include display of an indication that is not related to the item of the template document.

Accordingly, it is possible to perform the document review processing on the own standard that does not exist as an item in the template, such as the content specified not to be written in the agreement, and to provide a notification of the violation of the own standard.

In addition, in the information processing apparatus 10, the dissimilar item may include display of the missing item not included in the review target document among a plurality of items included in the template document.

Accordingly, it is possible to provide a notification of the violation of the own standard that does not exist as an item in the review target document, such as the content specified to be written in the agreement.

In addition, in the information processing apparatus 10, the display of the indication regarding the item of the template document corresponding to the dissimilar item may include a sentence example of the item of the template document and highlighting display of a difference portion of the sentence of the dissimilar item with respect to the sentence example.

Accordingly, it is possible to easily grasp which item has been altered or which wording of the item has been altered.

In addition, in the information processing apparatus 10, the output control unit 117 achieved by the at least one processor may collectively output at least one indication to be displayed among the plurality of items included in the template document.

Accordingly, only the desired indication can be easily downloaded according to the display.

In addition, in the information processing apparatus 10, the at least one processor may determine that the item of the review target document is a similar item when the wording of the item of the review target document matches the sentence example of the corresponding item included in the template document.

Accordingly, it is possible to omit confirmation for a portion of the review target document that has not been changed from the template document, and it is possible to suppress oversight that may occur when omission is made by determination by the user.

In addition, in the information processing apparatus 10, the review processing execution unit 115 achieved by the at least one processor may determine whether the item of the review target document is a similar item or a dissimilar item based on the correlation between the wording of the item of the review target document and the sentence example of the corresponding item included in the template document and weighted based on the correlation of the title of the item between the review target document and the template document.

Accordingly, in a case where a change is made in the review target document within an allowable range from the template document, that is, for a portion that has not been substantially changed from the template document, confirmation can be omitted.

Note that, in the above embodiment, the case where the document and the document review information are set as data of different files, and managed in association with each other is exemplified. On the other hand, data including the document and the document review information may be managed as one file.

In the above embodiment, the toggle, the icons, a button, and the like are displayed on the screen, but it is not limited thereto as long as the user can appropriately operate the display. In addition, other displays are not limited to the above-described embodiment, and appropriate contents can be selected.

Note that some or all of the apparatuses in the above-described embodiments may be configured by hardware, or may be configured by information processing of software (program) executed by a CPU, a GPU, or the like. In addition, in the above embodiments, when a plurality of storage apparatuses stores data, each storage apparatus of the plurality of storage apparatuses may store only a part of the data or may store the entire data.

As described above, the information processing method according to the embodiment may compare the first document including the plurality of items to be reviewed with the second document including a plurality of items and in which the indications are set to the plurality of items, determine whether the plurality of items of the first document are similar items or dissimilar items, generate the first display screen including the display in which the indication set in the second document is associated with the dissimilar item with respect to the dissimilar item and the display in which the indication simpler than the indication displayed when the item is the dissimilar item is associated with the similar item, and generate the second display screen in which the set indications are displayed with respect to the dissimilar item and the similar item, in which the first display screen and the second display screen can be switched and displayed.

In the information processing method described above, the first display screen may include display for instructing transition to the second display screen.

In the information processing method described above, the indication regarding the item of the second document corresponding to the dissimilar item may include at least one of the comment information included in the second document and the additional information associated with the second document.

In the information processing method described above, the second display screen may include display for instructing transition to the first display screen.

In the information processing method described above, the second document may include an indication not related to the item, and the first display screen may further include display of an indication not related to the item of the second document.

In the information processing method described above, the dissimilar item may include the missing item not included in the first document among the plurality of items included in the second document.

In the information processing method described above, the display of the indication regarding the item of the second document corresponding to the dissimilar item may include a sentence example of the item of the second document and emphasis display of a difference portion of the sentence of the dissimilar item with respect to the sentence example.

The information processing method described above may collectively output an indication regarding at least one item to be displayed among the plurality of items included in the second document.

The information processing method described above may determine that the item of the first document is the similar item when the wording of the item of the first document matches the sentence example of a corresponding item included in the second document.

The information processing method described above may determine whether the item of the first document is the similar item or the dissimilar item based on the correlation between the wording of the item of the first document and the sentence example of the corresponding item included in the second document and weighted based on the correlation of the title of the item between the first document and the second document.

The information processing apparatus according to the embodiment includes at least one processor. The at least one processor may compare the first document including the plurality of items to be reviewed with the second document including a plurality of items and in which the indications are set to the plurality of items, determine whether the plurality of items of the first document are similar items or dissimilar items, generate the first display screen including the display in which the indication set in the second document is associated with the dissimilar item with respect to the dissimilar item and the display in which the indication simpler than the indication displayed when the item is the dissimilar item is associated with the similar item, and generate the second display screen in which the set indications are displayed with respect to the dissimilar item and the similar item, in which the first display screen and the second display screen can be switched and displayed.

The information processing apparatus according to the embodiment may include at least one processor. The at least one processor may execute the information processing method described above.

An information processing system according to the embodiment may include the information processing apparatus described above and a terminal apparatus that communicates with the information processing apparatus described above. In the information processing apparatus, the at least one processor may output display information for displaying at least one of the first display screen and the second display screen. The terminal apparatus may include at least one processor that displays a display screen based on the display information output from the information processing apparatus.

The information processing program according to the embodiment may cause a computer to execute comparing the first document including the plurality of items to be reviewed with the second document including a plurality of items and in which the indications are set to the plurality of items, determining whether the plurality of items of the first document are similar items or dissimilar items, generating the first display screen including the display in which the indication set in the second document is associated with the dissimilar item with respect to the dissimilar item and the display in which the indication simpler than the indication displayed when the item is the dissimilar item is associated with the similar item, and generating the second display screen in which the set indications are displayed with respect to the dissimilar item and the similar item, in which the first display screen and the second display screen can be switched and displayed.

The information processing program according to the embodiment may cause a computer to execute the information processing method described above.

The recording medium according to the embodiment may be a program executed by a computer, and a storage medium (computer program product) in which the information processing program described above is recorded.

Although the embodiments of the present disclosure have been described in detail above, these embodiments have been presented as examples, and are not intended to be limited to individual embodiments. Each embodiment can be modified by various additions, changes, replacements, partial deletions, combinations, and the like without departing from the technical idea of the present invention. These embodiments and modifications thereof are included in the invention described in the claims and the equivalent scope thereof.

What is claimed is:

1. An information processing method comprising:
comparing a first document including a plurality of items to be reviewed with a second document including a plurality of items and in which indications are set to the plurality of items;
determining whether the plurality of items of the first document are similar items or dissimilar items;
generating a first display screen including display in which an indication set in the second document is associated with the dissimilar item with respect to the dissimilar item and display in which an indication simpler than an indication displayed when the item is the dissimilar item is associated with the similar item; and
generating a second display screen in which the set indications are displayed with respect to the dissimilar item and the similar item, wherein
the first display screen and the second display screen can be switched and displayed.

2. The information processing method according to claim 1, wherein
the first display screen includes display for instructing transition to the second display screen.

3. The information processing method according to claim 1, wherein
the indication regarding the item of the second document corresponding to the dissimilar item includes at least one of comment information included in the second document and additional information associated with the second document.

4. The information processing method according to claim 1, wherein
the second display screen includes display for instructing transition to the first display screen.

5. The information processing method according to claim 1, wherein
the second document includes an indication not related to the item, and
the first display screen further includes display of an indication not related to the item of the second document.

6. The information processing method according to claim 1, wherein
the dissimilar item includes a missing item not included in the first document among the plurality of items included in the second document.

7. The information processing method according to claim 1, wherein
the display of the indication regarding the item of the second document corresponding to the dissimilar item includes a sentence example of the item of the second document and emphasis display of a difference portion of a sentence of the dissimilar item with respect to the sentence example.

8. The information processing method according to claim 1, comprising collectively outputting an indication regarding at least one item to be displayed among the plurality of items included in the second document.

9. The information processing method according to claim 1, comprising
determining that the item of the first document is the similar item when wording of the item of the first document matches a sentence example of a corresponding item included in the second document.

10. The information processing method according to claim 1, comprising
determining whether the item of the first document is the similar item or the dissimilar item based on correlation between wording of the item of the first document and a sentence example of a corresponding item included in the second document and weighted based on correlation of a title of the item between the first document and the second document.

11. An information processing apparatus comprising:
at least one processor configured to:
compare a first document including a plurality of items to be reviewed with a second document including a plurality of items and in which indications are set to the plurality of items,
determine whether the plurality of items of the first document are similar items or dissimilar items,
generate a first display screen including display in which an indication set in the second document is associated with the dissimilar item with respect to the dissimilar item and display in which an indication simpler than an indication displayed when the item is the dissimilar item is associated with the similar item, and
generate a second display screen in which the set indications are displayed with respect to the dissimilar item and the similar item, and
the first display screen and the second display screen can be switched and displayed.

12. An information processing system comprising:
the information processing apparatus according to claim 11; and
a terminal apparatus that communicates with the information processing apparatus, wherein
in the information processing apparatus, the at least one processor outputs display information for displaying at least one of the first display screen and the second display screen, and
the terminal apparatus includes at least one processor that displays a display screen based on the display information output from the information processing apparatus.

13. A non-transitory computer-readable storage medium storing instructions thereon that, when executed by a computer, cause the computer to:
compare a first document including a plurality of items to be reviewed with a second document including a plurality of items and in which indications are set to the plurality of items;
determine whether the plurality of items of the first document are similar items or dissimilar items;
generate a first display screen including display in which an indication set in the second document is associated with the dissimilar item with respect to the dissimilar item and display in which an indication simpler than an indication displayed when the item is the dissimilar item is associated with the similar item;
generate a second display screen in which the set indications are displayed with respect to the dissimilar item and the similar item; and
enable switching and display of the first display screen and the second display screen.
